(19) United States
(12) Patent Application Publication
(10) Pub. No.: US 2026/0148467 A1
(43) Pub. Date: May 28, 2026

(54) METHOD, DEVICE, AND NON-TRANSITORY COMPUTER-READABLE STORAGE MEDIUM

(71) Applicant: CANON KABUSHIKI KAISHA, Tokyo (JP)

(72) Inventor: TOMOHIRO HIGUCHI, Kanagawa (JP)

(21) Appl. No.: 19/385,687

(22) Filed: Nov. 11, 2025

(30) Foreign Application Priority Data
Nov. 25, 2024 (JP) 2024-204577

(51) Int. Cl. G06T 15/00; G06T 7/73; G06T 17/00

(52) U.S. Cl. CPC G06T 15/00; G06T 7/75; G06T 17/00; G06T 2200/04

(57) ABSTRACT

The aspect of the embodiments is directed to a method for generating multiple mutually parallel cross-sectional images from a three-dimensional shape model. The method includes acquiring multiple values indicating distances from a prescribed plane to each part of the three-dimensional shape model, determining distances from the prescribed plane based on the multiple values, and generating the cross-sectional images at the determined distances.

### BACKGROUND

### Field of the Technology

The aspect of the embodiments relates to a method, a device, and a non-transitory computer-readable storage medium.

### Description of the Related Art

Multiple mutually parallel cross-sectional images of a three-dimensional shape model are used in a variety of fields and applications for all kinds of objects, including real objects and virtual objects.

Japanese Patent Laid-Open No. 2021-148731 proposes a method for generating multiple mutually parallel cross-sectional images of a portion of an object when measuring the shape of the object, and measuring the portion on the basis of the multiple cross-sectional images.

According to the method in Japanese Patent Laid-Open No. 2021-148731, when generating multiple mutually parallel cross-sectional images of an object, the cross-sectional images are captured at equally spaced intervals. Since this results in the generation of multiple similar cross-sectional images at positions where there is little change in cross-sectional shape, the above method may be inadequate in terms of efficiency from the perspective of calculation speed and efficient computer memory utilization.

### SUMMARY

The aspect of the embodiments is directed to a method for generating multiple mutually parallel cross-sectional images from a three-dimensional shape model. The method includes acquiring multiple values indicating distances from a prescribed plane to each part of the three-dimensional shape model, determining distances from the prescribed plane based on the multiple values, and generating the cross-sectional images at the determined distances. In the acquiring, the distances are detected as distances at which a minimum value among the multiple values changes by an amount equal to or greater than a threshold value.

Features of the disclosure will become apparent from the following description of embodiments with reference to the attached drawings. The following description of embodiments is described by way of example.

### BRIEF DESCRIPTION OF THE DRAWINGS

FIG. 1 is a basic processing flowchart according to a first embodiment.

FIG. 2 is a flowchart illustrating details of the processing in S5 of FIG. 1 according to the first embodiment.

FIG. 3 is a diagram illustrating an example of the configuration of an information processing device according to the first embodiment.

FIG. 4 is a diagram illustrating an example of a three-dimensional shape model according to the first embodiment.

FIG. 5 is a diagram illustrating an example of a slice image generated from the three-dimensional shape model in FIG. 4 according to the first embodiment.

FIG. 6 is a diagram illustrating an example of a depth value distribution for FIG. 5 according to the first embodiment.

FIG. 7 is a diagram illustrating examples of slice images generated from a three-dimensional shape model according to the first embodiment.

FIG. 8 is a flowchart illustrating details of the processing in S5 of FIG. 1 according to a second embodiment.

FIG. 9 is a diagram illustrating an example of a depth value distribution on which a search for a cross-sectional change position is performed according to the second embodiment.

FIG. 10 is a diagram illustrating an example of a detected cross-sectional change position according to the second embodiment.

FIG. 11 is a diagram illustrating examples of slice images generated from a three-dimensional shape model according to the second embodiment.

### DESCRIPTION OF THE EMBODIMENTS

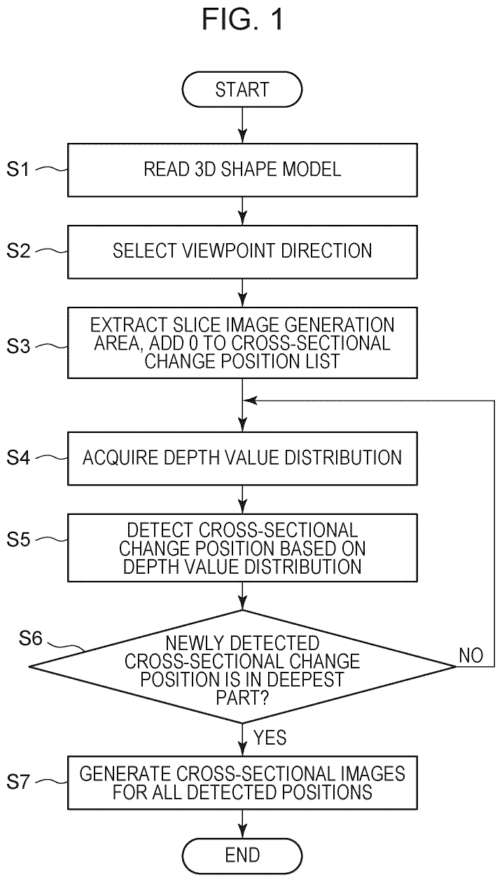

A first embodiment of the disclosure will be described using FIG. 1. FIG. 1 illustrates a flowchart of processing according to the first embodiment.

S1 is processing for reading a three-dimensional shape model of which slice images are to be generated. The file format of the three-dimensional shape model is not limited. For example, a file format such as STL, STEP, or OBJ is used.

S2 is processing for selecting a viewpoint direction when generating slice images of the read three-dimensional shape model. The viewpoint direction is selected to be a direction from which unevenness of the shape can be observed when depth values are acquired, so that the characteristics of cross-sectional changes in the three-dimensional shape are captured accurately.

S3 is processing for extracting a slice image generation area in the read three-dimensional shape model and adding a reference position with a depth value of 0 as a first element to a cross-sectional change position list. The reference position with a depth value of 0 may be selected by an operator, or may be selected by automatically acquiring the position of the plane that is frontmost when viewed from the viewpoint direction selected in S2 in the slice image generation area extracted in S3. Also, the slice image generation area to be extracted may be the entirety of the three-dimensional shape model or a portion of the three-dimensional shape model.

S4 is processing for acquiring a depth value distribution when viewed from the viewpoint direction selected in S2 for the slice image generation area extracted in S3.

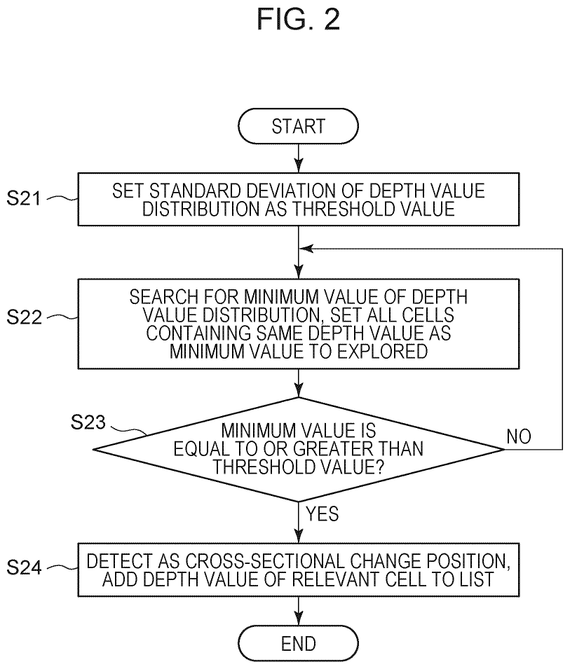

S5 is processing for detecting a cross-sectional change position on the basis of the depth value distribution acquired in S4.
Details of the processing in S5 will be described later in the explanation of FIG. 2.

S6 is processing for determining whether the cross-sectional change position newly added to the cross-sectional change position list in the processing in S5 has reached the deepest position when viewed from the viewpoint direction selected in S2. If it is determined that the deepest position has not been reached, the flow returns to S4, the cross-sectional change position added to the list is newly set as the reference position with a depth value of 0, a depth value distribution is acquired, and the flow advances to the processing in S5. If it is determined that the deepest position has been reached, the flow advances to the processing in step S7.

S7 is processing for generating cross-sectional images at all positions on the cross-sectional change position list detected by the processing from S1 to S6.

In other words, in S1 to S7, the following processing is performed. First, with respect to the read three-dimensional shape model, multiple values indicating depths from a prescribed plane (the reference position with a depth value of 0 selected in S3) to respective parts of the three-dimensional shape model are acquired (S4). Next, distances from the prescribed plane are determined on the basis of the multiple values acquired in S4 (S5). Cross-sectional images are then generated (S7) at the determined distances.

FIG. 2 is a flowchart illustrating details of the processing in S5 of FIG. 1.

S21 is processing for calculating the standard deviation of the acquired depth value distribution and setting the calculated standard deviation as a threshold value to be used for detection of a cross-sectional change position.

S22 represents processing for searching unexplored cells to find a minimum depth value in the depth value distribution.
Also, at this time, cells having the same depth value as the minimum depth are all set as explored.

S23 is processing for determining whether or not the minimum depth value is equal to or greater than the threshold value set in S21. If the minimum depth value is less than the threshold value, the flow returns to S22 and another search is performed to find the minimum depth value in the depth value distribution. If the minimum depth value is equal to or greater than the threshold value, the flow proceeds to step S24.

S24 is processing for, if it is determined in S23 that the minimum depth value is equal to or greater than the threshold value, detecting that depth value as a cross-sectional change position and adding a depth position corresponding to that depth value to the cross-sectional change position list.

The above processing flow enables efficient slice image generation that keeps the number of images to the minimum necessary in accordance with cross-sectional changes in the three-dimensional shape model.

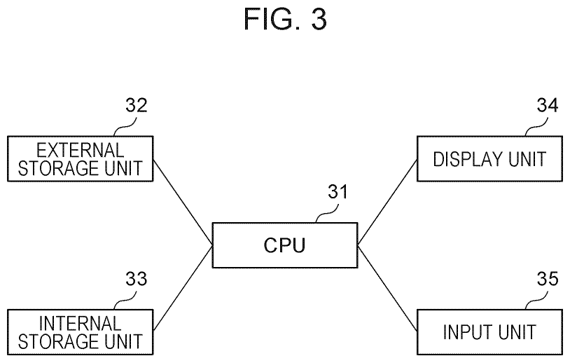

FIG. 3 is an example of a device according to the disclosure. An external storage unit 32, an internal storage unit 33, a display unit 34, and an input unit 35 are connected to a processing unit, namely a central processing unit (CPU) 31.

The CPU 31 executes processing according to program instructions. The external storage unit 32 is a device that saves a program (hereinafter, the program) describing processing to be executed by the CPU 31 in the disclosure, results of processing by the CPU 31, and the like, and may be a hard disk.

The internal storage unit 33 is a device that temporarily saves information to be used partway through processing by the CPU 31, and the like, and may be random-access memory (RAM). The display unit 34 is a device that displays slice images generated through processing by the CPU 31, and the like, and may be a display, for example. The input unit 35 is a device used by an operator to enter information necessary for processing by the CPU 31, and may be a keyboard and/or a mouse, for example.

A specific example of a slice image generation procedure according to the embodiment will be described with reference to the flowchart illustrated in FIG. 1.

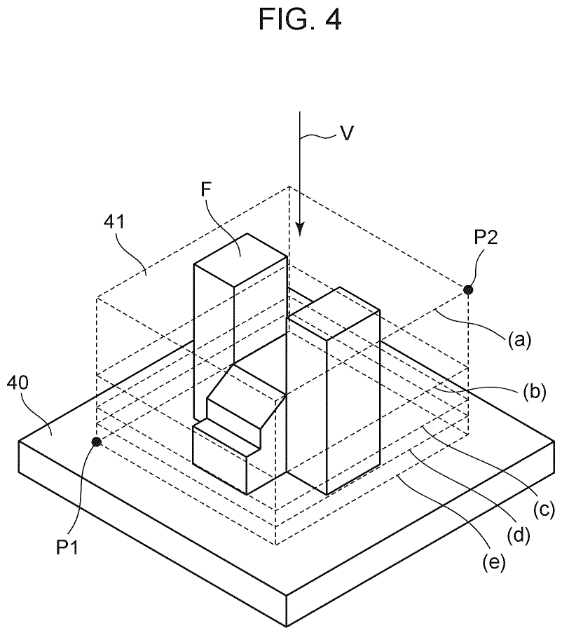

In S1, a three-dimensional shape model which is saved in the external storage unit 32 and of which slice images are to be generated is read. In the embodiment, the three-dimensional shape model 40 illustrated in FIG. 4 is assumed to be handled as an example.

In the three-dimensional shape model 40 illustrated in FIG. 4, a shape made up of rectangular cuboids and a rectangular frustum is placed on top of a flat panel. FIG. 4 illustrates a viewpoint direction V, which is the directional orthogonal to the cross sections for generating slice images of the three-dimensional shape model 40, and a plane F, which is located frontmost when the three-dimensional shape model 40 is viewed from the viewpoint direction V. FIG. 4 also illustrates two points P1 and P2, which are the endpoints of a bounding box representing a slice image generation area 41 in the three-dimensional shape model 40. Also, a plane (a), a plane (b), a plane (c), a plane (d), and a plane (e) in FIG. 4 indicate the cross-sectional positions of slice images to be generated with respect to the slice image generation area 41.

The three-dimensional shape model data acquired in S1 is stored in the internal storage unit 33 according to an instruction from the CPU 31. The three-dimensional shape model data is also displayed on the display unit 34 according to an instruction from the CPU 31.

In S2, the viewpoint direction V when generating slice images of the three-dimensional shape model 40 read in S1 is selected. The selection method may involve selection by the operator via the input unit 35, or a viewpoint direction may be selected automatically according to a predetermined rule. A viewpoint direction may also be selected by causing a machine learning model to estimate a viewpoint direction.

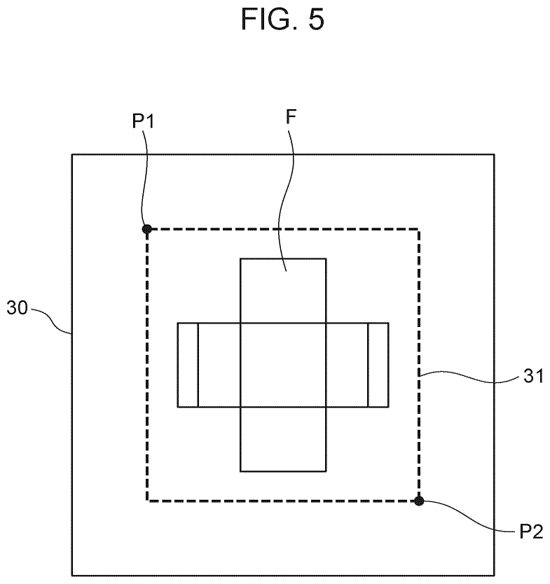

The viewpoint direction V selected in S2 is stored in the internal storage unit 33 by the CPU 31. Also, the viewpoint direction V may be displayed on the display unit 34, the viewpoint of the three-dimensional shape model 40 displayed on the display unit 34 may be changed to a viewpoint as seen from the viewpoint direction V, and/or the like. FIG. 5 illustrates what the three-dimensional shape model 40 looks like when viewed from the viewpoint direction V.

In S3, the slice image generation area 41 in the three-dimensional shape model 40 read in S1 is extracted. The method for extracting the slice image generation area 41 may involve extraction specified by the operator via the input unit 35, automatic extraction according to a predetermined rule, or automatic extraction using a machine learning model. Also, at this time, a reference position with a depth value of 0 is added as a first element to the cross-sectional change position list.

In S4, a depth value distribution of the three-dimensional shape model when viewed from the viewpoint direction V selected in S2 is acquired for the slice image generation area 41 extracted in S3. When S4 is executed for the first time, the plane that is frontmost when viewed from the viewpoint direction V is selected as the reference position with a depth value of 0, and a depth value distribution from the reference position is acquired. When S4 is executed for the second and subsequent times, the next-deepest position on the cross-sectional change position list is selected as the reference position with a depth value of 0, a depth value distribution from the reference position is acquired again, and the processing from S4 to S6 is repeated until the deepest part is reached. The acquired depth value distribution is stored in the internal storage unit 33. At this time, cells with a depth value of 0 are all set to explored.

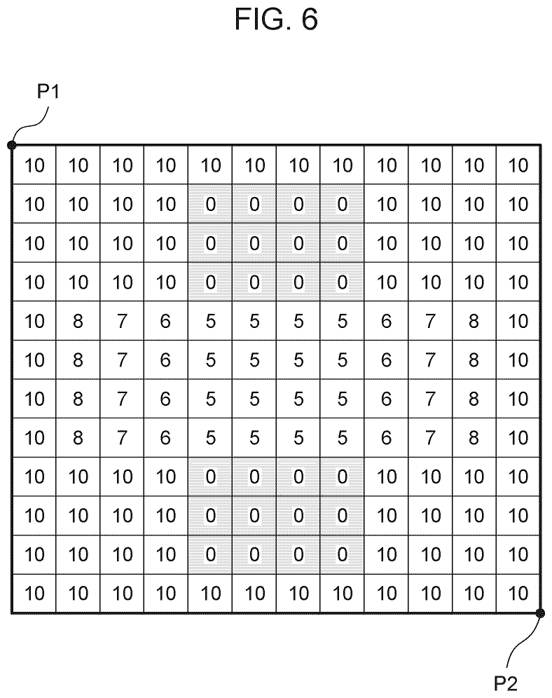

FIG. 6 illustrates the depth value distribution in a case where a plane F, which is frontmost when the slice image generation area 41 of the three-dimensional shape model 40 in FIG. 4 is viewed from the viewpoint direction V, is acquired as the reference position with a depth value of 0.
In FIG. 6, explored cells are shaded gray.

In S5, a cross-sectional change position is detected on the basis of the depth value distribution acquired in S4. The following describes the processing in S5 according to the flowchart in FIG. 2.

In S21, the standard deviation of the acquired depth value distribution is calculated and set as a threshold value to be used for detection of a cross-sectional change position. In this example, a standard deviation of 3.7 is calculated from the depth value distribution in FIG. 6 acquired by the processing in S4. Thus, 3.7 is set as the threshold value to be used for cross-sectional change position detection.

In S22, unexplored cells are searched to find a minimum depth value in the depth value distribution. Also, at this time, cells having the same depth value as the minimum depth are all set to explored. If the depth value distribution in FIG. 6 is searched, a minimum value of 5 is found among the unexplored cells. Cells having the same depth value as the minimum value of 5 are all set to explored.

In S23, it is determined whether or not the minimum value found in S22 is equal to or greater than the threshold value set in S21, and the flow branches conditionally. If the minimum value is less than the threshold value, the flow returns to S22 and a search is performed to find the minimum value in the depth value distribution. If the minimum value is equal to or greater than the threshold value, the flow proceeds to step S24. In this example, the minimum value of 5 is equal to or greater than the threshold value of 3.7, and consequently the flow proceeds to step S24.

In S24, the depth value for which it is determined in S23 that the minimum value is equal to or greater than the threshold value is detected as a cross-sectional change position, and a depth position corresponding to that depth value is added to the cross-sectional change position list.
In this example, the depth value of 5 is found and determined to be equal to or greater than the threshold value, and thus the depth position corresponding to the depth value of 5 is added to the cross-sectional change position list, and the processing proceeds to step S6. At this point, the processing of the flow in FIG. 2 ends, and the flow proceeds to the processing in step S6 of FIG. 1.

In S6, it is determined whether the cross-sectional change position newly added to the cross-sectional change position list in the processing in S5 has reached the deepest position when viewed from the viewpoint direction selected in S2. If it is determined that the deepest position has not been reached, the flow returns to S4, the cross-sectional change position newly added to the list is treated as the reference position with a depth value of 0, a depth value distribution is acquired, and the flow proceeds to the processing in S5 again. If it is determined that the deepest position has been reached, the flow proceeds to the processing in step S7.

In S7, cross-sectional images are generated at all positions on the cross-sectional change position list detected by the processing from S1 to S6. The plane (a), the plane (b), the plane (c), the plane (d), and the plane (e) in FIG. 4 are the cross-sectional positions of slice images to be generated with respect to the slice image generation area 41.

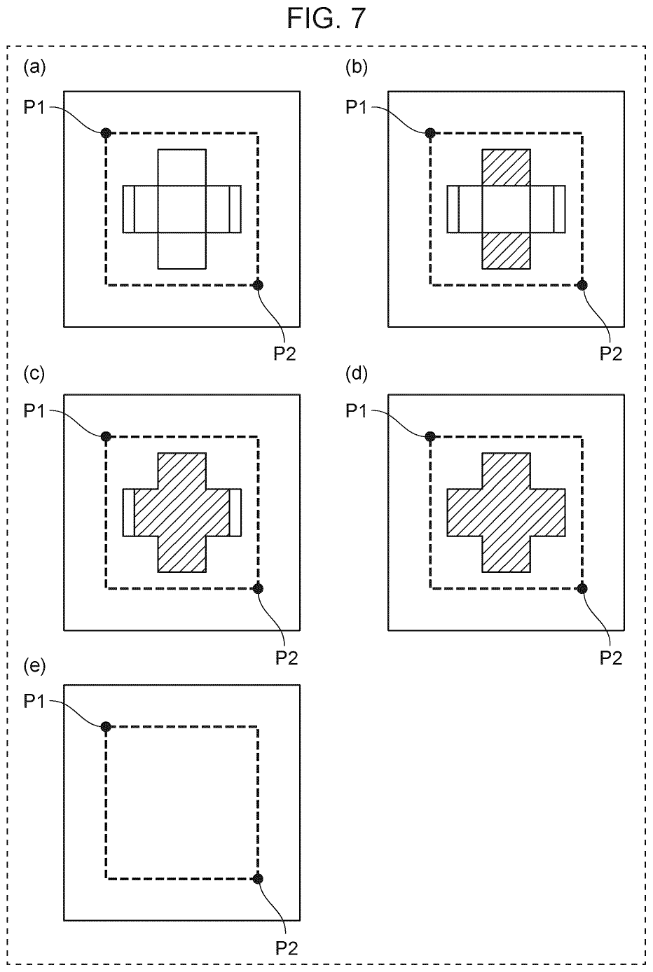

FIG. 7 illustrates respective slice images of the plane (a), the plane (b), the plane (c), the plane (d), and the plane (e), these slice images being generated by executing the processing in S7 with respect to the slice image generation area 41. In this example, the plane (a), the plane (b), the plane (c), the plane (d), and the plane (e) have depth positions of 0, 5, 8, 9, and 10, respectively.

A series of slice images like those illustrated in FIG. 7 acquired in this way and the respective depth positions thereof are stored in the external storage unit 32.

This enables efficient generation of multiple mutually parallel cross-sectional images of a three-dimensional shape model.

### Second Embodiment

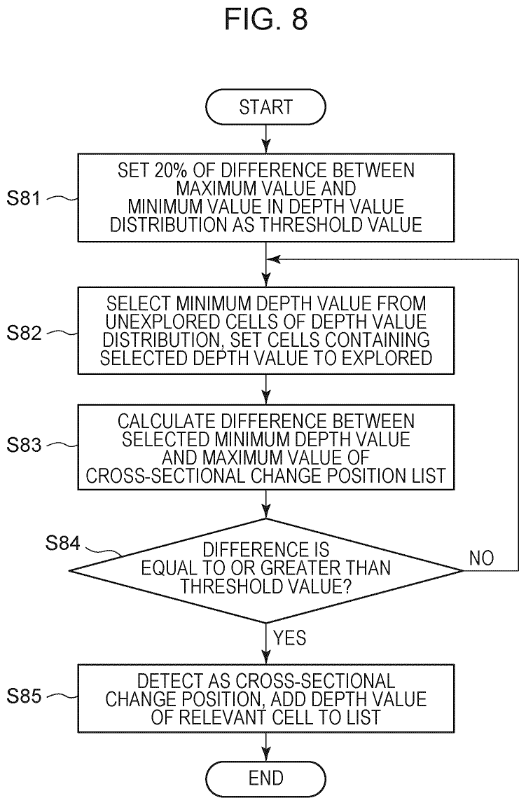

The second embodiment describes a case where the detection of a cross-sectional change position in S5 of FIG. 1 is performed according to a procedure different from the first embodiment. Note that for portions similar to the first embodiment, a description will be omitted, as appropriate. FIG. 8 illustrates a flowchart of a method for detecting a cross-sectional change position in S5 of FIG. 1 according to the embodiment.

First, processing similar to the first embodiment is executed in steps S1 to S4 of FIG. 1. In a manner similar to the first embodiment, a depth value distribution like the one illustrated in FIG. 6 is acquired, and 0 is added as a first element of the cross-sectional change position list. Next, the flow proceeds to the processing in S5. In the embodiment, the processing in S81 to S85 below is performed.

S81 is processing for setting a value equal to 20% of the difference between the maximum value and the minimum value in the depth value distribution as a threshold value for detecting a cross-sectional change position. In the embodiment, a value equal to 20% of the difference is set as an example, but this value may be changed, as appropriate, to a suitable coefficient that allows for more accurate capturing of changes in depth values, depending on the depth value distribution. The value equal to 20% of the difference between the maximum value and the minimum value in the depth value distribution in FIG. 6 is 2, and therefore the threshold value for detecting a cross-sectional change position is set to 2.

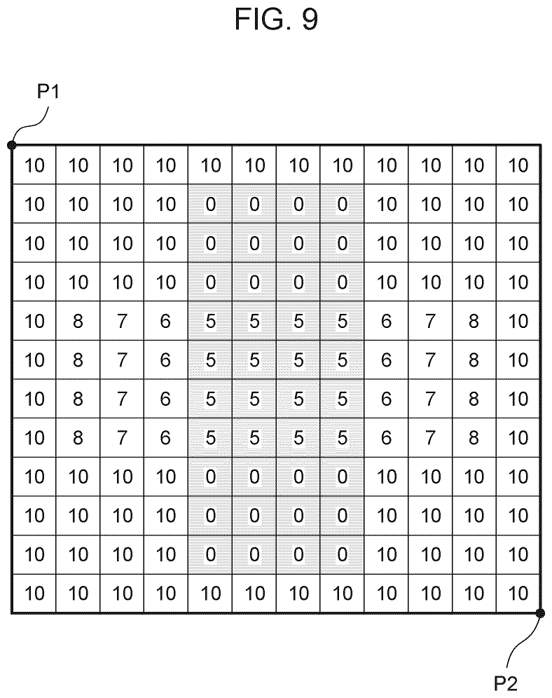

S82 is processing for selecting the minimum depth value from unexplored cells of the depth value distribution and setting all cells containing that depth value to explored. In the case of the depth value distribution in FIG. 6, the minimum depth value among the unexplored cells is 5, and therefore the cells with a depth value of 5 are all set to explored. FIG. 9 illustrates a depth value distribution after executing the processing in S82 with respect to the depth value distribution in FIG. 6.

S83 represents processing for calculating the difference between the minimum depth value selected in S82 and the maximum value on the cross-sectional change position list. In the case of the depth value distribution in FIGS. 6, 5 is calculated as the difference between the minimum depth value of 5 and the maximum value of 10 on the cross-sectional change position list.

S84 represents processing for determining whether the difference calculated in S83 is equal to or greater than the threshold value for detecting a cross-sectional change position, and conditionally branching the flow. If the difference is equal to or greater than the threshold value, the flow proceeds to the processing in S85, whereas if the difference is less than the threshold value, the flow returns to the processing in S82. Even in the case where the difference is less than threshold value, if the deepest part of the slice image generation area 41 has been reached, the depth value of the deepest part is detected as a cross-sectional change position, and the flow proceeds to the processing in S85. In the case of the depth value distribution in FIG. 6, the difference of 5 calculated in S83 is equal to or greater than the threshold value of 2 for detecting a cross-sectional change position, and therefore the flow proceeds to the processing in S85.

S85 represents processing for detecting the minimum depth value selected in S82 from the depth value distribution as a cross-sectional change position, and adding a depth position corresponding to the depth value of the relevant cell to the cross-sectional change position list.

In S6 of FIG. 1, in a manner similar to the first embodiment, it is determined whether the new cross-sectional change position detected in S81 to S85 is the deepest part of the three-dimensional shape model, and if the deepest part has been reached, the flow proceeds to the processing in S7. If the deepest part has not been reached, the flow returns to the processing in S4.

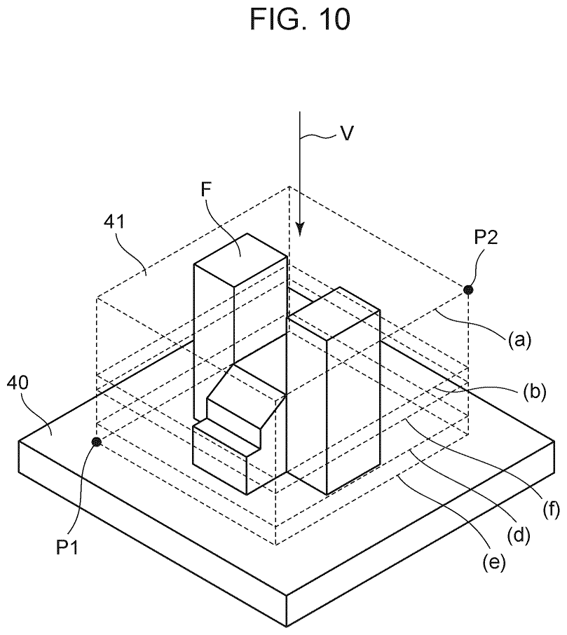

In S7 of FIG. 1, in a manner similar to the first embodiment, slice images are generated at all cross-sectional change positions on the cross-sectional change position list to which elements have been added by the processing up to S6. For example, the cross-sectional change positions detected for the slice image generation area 41 of the three-dimensional shape model 40 illustrated in FIG. 10 are the plane (a), the plane (b), a plane (f), the plane (d), and the plane (e), and the depth positions are 0, 5, 7, 9, and 10, respectively.

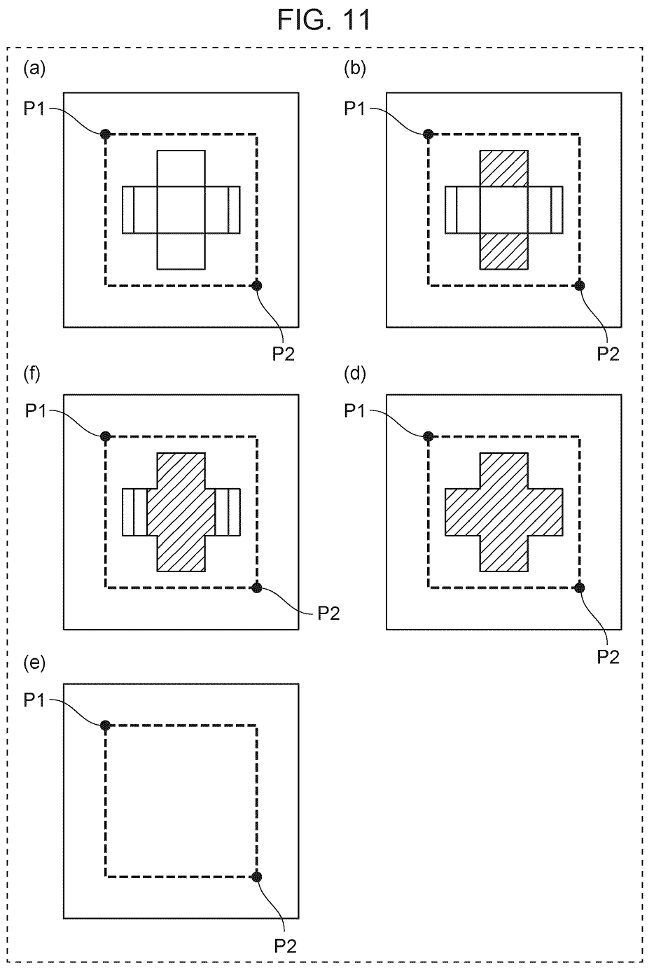

FIG. 11 illustrates slice images generated with respect to these cross-sectional change positions. A series of slice images generated in this way is saved in the external storage unit 32 or elsewhere.

Thus, efficient generation of multiple mutually parallel cross-sectional images of a three-dimensional shape model is also possible by the above approach that is different from the first embodiment.

### Other Embodiments

A control program that can be used to execute the method described above and a storage medium on which the control program is stored in a computer-readable form are also included among embodiments of the disclosure. For example, ROM, a disc/disk, an external storage device, or the like may be used as the storage medium for supplying the control program. Described in terms of specific examples, a flexible disk, an optical disc, a magneto-optical disc, magnetic tape, non-volatile memory such as USB memory, an SSD, or the like can be used as a non-transitory computer-readable storage medium.

The disclosure is also achievable by a process of supplying a program for achieving one or more functions of the embodiments to a system or a device via a network or a storage medium, and having one or more processors in a computer of the system or device read out and execute the program. The disclosure is also achievable by a circuit (for example, an ASIC) that achieves the one or more functions.

Furthermore, the disclosure is not limited to the above embodiments in unaltered form, but can be concretely realized in the implementation stage by modifying the components within a scope that does not depart from the gist of the disclosure. Furthermore, multiple components of each the above embodiments may be combined appropriately. Some components may also be removed from among the multiple components indicated in each of the embodiments. Furthermore, components across different embodiments may be combined appropriately.

The disclosure of the embodiments includes the following configurations.

### Item 1

A method for generating a plurality of mutually parallel cross-sectional images from a three-dimensional shape model, the method comprising:
acquiring a plurality of values indicating distances from a prescribed plane to each part of the three-dimensional shape model;
determining distances from the prescribed plane based on the plurality of values; and
generating the cross-sectional images at the determined distances,
wherein in the acquiring, the distances are detected as distances at which a minimum value among the plurality of values changes by an amount equal to or greater than a threshold value.

### Item 2

The method according to item 1, wherein, in the acquiring, the threshold value is the standard deviation of the plurality of values.

### Item 3

The method according to item 2, wherein, in the acquiring, the threshold value is based on the difference between a maximum value and a minimum value of the plurality of values.

### Item 4

The method according to item 2, wherein, in the acquiring, the threshold value is obtained by multiplying the difference between a maximum value and a minimum value of the plurality of values by a coefficient.

### Item 5

The method according to any one of items 1 to 4, further comprising displaying, after the generating, the cross-sectional images generated by the generating.

### Item 6

The method according to any one of items 1 to 4, further comprising storing, after the generating, the cross-sectional images generated by the generating.

### Item 7

A device that includes a processing unit and generates a plurality of mutually parallel cross-sectional images from a three-dimensional shape model, wherein
the processing unit is configured to determine distances from a prescribed plane based on a plurality of values indicating distances from the prescribed plane to each part of the three-dimensional shape model and generate the cross-sectional images at the determined distances, and
the processing unit is configured to detect the distances as distances at which a minimum value among the plurality of values changes by an amount equal to or greater than a threshold value.

### Item 8

The device according to item 7, wherein the threshold value is the standard deviation of the plurality of values.

### Item 9

The device according to item 7, wherein the threshold value is based on the difference between a maximum value and a minimum value of the plurality of values.

### Item 10

The device according to item 9, wherein the threshold value is obtained by multiplying the difference between a maximum value and a minimum value of the plurality of values by a coefficient.

### Item 11

The device according to any one of items 7 to 10, further comprising a display unit configured to display the cross-sectional images.

### Item 12

The device according to any one of items 7 to 11, further comprising a storage unit configured to store the cross-sectional images.

### Item 13

A program for causing a computer to execute the method according to any one of items 1 to 6.

### Item 14

A non-transitory computer-readable storage medium containing the program according to item 13.

According to a method of the disclosure, multiple mutually parallel cross-sectional images of a three-dimensional shape model can be generated more efficiently.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-204577, filed Nov. 25, 2024, which is hereby incorporated by reference herein in its entirety.

What is claimed is:

1. A method for generating a plurality of mutually parallel cross-sectional images from a three-dimensional shape model, the method comprising:
acquiring a plurality of values indicating distances from a prescribed plane to each part of the three-dimensional shape model;
determining distances from the prescribed plane based on the plurality of values; and
generating the cross-sectional images at the determined distances,
wherein, in the acquiring, the distances are detected as distances at which a minimum value among the plurality of values changes by an amount equal to or greater than a threshold value.

2. The method according to claim 1, wherein, in the acquiring, the threshold value is the standard deviation of the plurality of values.

3. The method according to claim 1, wherein, in the acquiring, the threshold value is based on the difference between a maximum value and a minimum value of the plurality of values.

4. The method according to claim 3, wherein, in the acquiring, the threshold value is obtained by multiplying the difference between a maximum value and a minimum value of the plurality of values by a coefficient.

5. The method according to claim 1, further comprising displaying, after the generating, the cross-sectional images generated by the generating.

6. The method according to claim 1, further comprising storing, after the generating, the cross-sectional images generated by the generating.

7. A device that includes a processing unit and generates a plurality of mutually parallel cross-sectional images from a three-dimensional shape model, wherein
the processing unit is configured to determine distances from a prescribed plane based on a plurality of values indicating distances from the prescribed plane to each part of the three-dimensional shape model and generate the cross-sectional images at the determined distances, and
the processing unit is configured to detect the distances as distances at which a minimum value among the plurality of values changes by an amount equal to or greater than a threshold value.

8. The device according to claim 7, wherein the threshold value is the standard deviation of the plurality of values.

9. The device according to claim 7, wherein the threshold value is based on the difference between a maximum value and a minimum value of the plurality of values.

10. The device according to claim 9, wherein the threshold value is obtained by multiplying the difference between a maximum value and a minimum value of the plurality of values by a coefficient.

11. The device according to claim 7, further comprising a display unit configured to display the cross-sectional images.

12. The device according to claim 7, further comprising a storage unit configured to store the cross-sectional images.

13. A non-transitory computer-readable storage medium having recorded thereon a program for causing a computer to perform a method, the method comprising:
acquiring a plurality of values indicating distances from a prescribed plane to each part of the three-dimensional shape model;
determining distances from the prescribed plane based on the plurality of values; and
generating the cross-sectional images at the determined distances,
wherein in the acquiring, the distances are detected as distances at which a minimum value among the plurality of values changes by an amount equal to or greater than a threshold value.

14. The non-transitory computer-readable storage medium according to claim 13, wherein, in the acquiring, the threshold value is the standard deviation of the plurality of values.

15. The non-transitory computer-readable storage medium according to claim 13, wherein, in the acquiring, the threshold value is based on the difference between a maximum value and a minimum value of the plurality of values.

16. The non-transitory computer-readable storage medium according to claim 15, wherein, in the acquiring, the threshold value is obtained by multiplying the difference between a maximum value and a minimum value of the plurality of values by a coefficient.

17. The non-transitory computer-readable storage medium according to claim 13, further comprising displaying, after the generating, the cross-sectional images generated by the generating.

18. The non-transitory computer-readable storage medium according to claim 13, further comprising storing, after the generating, the cross-sectional images generated by the generating.
